(19) United States
(12) Patent Application Publication
(10) Pub. No.: US 2025/0070526 A1
(43) Pub. Date: Feb. 27, 2025

(54) LINE NARROWING MODULE, MANUFACTURING METHOD OF LINE NARROWING MODULE, AND ELECTRONIC DEVICE MANUFACTURING METHOD

(71) Applicant: Gigaphoton Inc., Tochigi (JP)

(72) Inventors: Masanori YASHIRO, Oyama-shi (JP); Hitoshi OHGA, Oyama-shi (JP); Ryouta KUJIRA, Oyama-shi (JP)

(73) Assignee: Gigaphoton Inc., Tochigi (JP)

(21) Appl. No.: 18/938,048

(22) Filed: Nov. 5, 2024

Related U.S. Application Data
(63) Continuation of application No. PCT/JP2022/022505, filed on Jun. 2, 2022.

(51) Int. Cl. H01S 3/00; H01S 3/03

(52) U.S. Cl. CPC H01S 3/0085; H01S 3/03

(57) ABSTRACT

A line narrowing module includes a mirror including a bottom surface and a reflection surface of light; a grating configured to wavelength-disperse the light reflected by the reflection surface; a base plate to which the bottom surface of the mirror is fixed with an adhesive; a rotation stage configured to rotate the base plate, arranged thereon, about a rotation axis perpendicular to a plane in which the light is wavelength-dispersed to rotate the mirror about the rotation axis; and a drive unit configured to rotate the rotation stage about the rotation axis. A centroid of the mirror, a centroid of the adhesive, a centroid of the base plate, and a centroid of the rotation stage are located on the rotation axis.

### CROSS-REFERENCE TO RELATED APPLICATIONS

The present application claims the benefit of International Application No. PCT/JP2022/022505, filed on Jun. 2, 2022, the entire contents of which are hereby incorporated by reference.

### BACKGROUND

### 1. Technical Field

The present disclosure relates to a line narrowing module, a manufacturing method of a line narrowing module, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 pm to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectral line width. In the following, a gas laser device with a narrowed spectral line width is referred to as a line narrowing gas laser device.

### LIST OF DOCUMENTS

### Patent Documents

Patent Document 1: US Patent Application No. 2021/0336407
Patent Document 2: Japanese Patent Application No. 2007-219160
Patent Document 3: Japanese Patent No. 5331827

### SUMMARY

A line narrowing module according to an aspect of the present disclosure includes a mirror including a bottom surface and a reflection surface of light; a grating configured to wavelength-disperse the light reflected by the reflection surface; a base plate to which the bottom surface of the mirror is fixed with an adhesive; a rotation stage configured to rotate the base plate, arranged thereon, about a rotation axis perpendicular to a plane in which the light is wavelength-dispersed to rotate the mirror about the rotation axis; and a drive unit configured to rotate the rotation stage about the rotation axis. Here, a centroid of the mirror, a centroid of the adhesive, a centroid of the base plate, and a centroid of the rotation stage are located on the rotation axis.

A manufacturing method of a line narrowing module according to an aspect of the present disclosure includes an assembly process for assembling a mirror, an adhesive, a base plate, and a rotation stage so that a centroid of the mirror, a centroid of the adhesive, a centroid of the base plate, and a centroid of the rotation stage are located on a rotation axis perpendicular to a plane in which light is wavelength-dispersed. Here, the line narrowing module includes the mirror including a bottom surface and a reflection surface of the light; a grating configured to wavelength-disperse the light reflected by the reflection surface; the base plate to which the bottom surface of the mirror is fixed with the adhesive; the rotation stage configured to rotate the base plate, arranged thereon, about the rotation axis to rotate the mirror about the rotation axis; and a drive unit configured to rotate the rotation stage about the rotation axis.

An electronic device manufacturing method according to an aspect of the present disclosure includes generating laser light using a gas laser device including a line narrowing module, outputting the laser light to an exposure apparatus, and exposing a photosensitive substrate to the laser light in the exposure apparatus to manufacture an electronic device. Here, the line narrowing module includes a mirror including a bottom surface and a reflection surface of light; a grating configured to wavelength-disperse the light reflected by the reflection surface; a base plate to which the bottom surface of the mirror is fixed with the adhesive; a rotation stage configured to rotate the base plate, arranged thereon, about a rotation axis perpendicular to a plane in which the light is wavelength-dispersed to rotate the mirror about the rotation axis; and a drive unit configured to rotate the rotation stage about the rotation axis. A centroid of the mirror, a centroid of the adhesive, a centroid of the base plate, and a centroid of the rotation stage are located on the rotation axis.

### BRIEF DESCRIPTION OF THE DRAWINGS

Embodiments of the present disclosure will be described below merely as examples with reference to the accompanying drawings.

FIG. 1 is a schematic view showing a schematic configuration example of an entire electronic device manufacturing apparatus.

FIG. 2 is a schematic view showing a schematic configuration example of an entire gas laser device of a comparative example.

FIG. 3 is a front view of a mirror unit of the comparative example.

FIG. 4 is a top view of the mirror unit of the comparative example.

FIG. 5 is a side view of the mirror unit of the comparative example.

FIG. 6 is a top view of a drive unit.

FIG. 7 is a front view of the mirror unit of a first embodiment.

FIG. 8 is a top view of the mirror unit of the first embodiment.

FIG. 9 is a side view of the mirror unit of the first embodiment.

FIG. 10 is a flowchart showing an assembly process in a manufacturing method of a line narrowing module of the first embodiment.

FIG. 11 is a front view of a mirror in a mirror fixing step.

FIG. 12 is a side view of the mirror in the mirror fixing step.

FIG. 13 is a view showing a state in which an adhesive is applied to a side surface of the mirror and a base plate in the mirror fixing step of the first embodiment.

FIG. 14 is a side view of the mirror unit of a second embodiment.

FIG. 15 is a side view of the mirror unit of a modification of the second embodiment.

FIG. 16 is a front view of the mirror unit of a third embodiment.

FIG. 17 is a top view of the mirror unit of the third embodiment.

FIG. 18 is a side view of the mirror unit of the third embodiment.

FIG. 19 is a view for explaining a state in which the adhesive is applied to a back surface of the mirror and abutting surfaces of the base plate in the mirror fixing step of the third embodiment.

### DESCRIPTION OF EMBODIMENTS

1. Description of electronic device manufacturing apparatus used in exposure process for electronic device
2. Description of gas laser device of comparative example
   2.1 Configuration
   2.2 Operation
   2.3 Problem
3. Description of line narrowing module of first embodiment
   3.1 Configuration
   3.2 Manufacturing method of line narrowing module
   3.3 Effect
4. Description of line narrowing module of second embodiment
   4.1 Configuration
   4.2 Effect
5. Description of line narrowing module of third embodiment
   5.1 Configuration
   5.2 Manufacturing method of line narrowing module
   5.3 Effect

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted. Further, in some of the drawings, reference numerals of some components are omitted for easy viewing.

### 1. Description of Electronic Device Manufacturing Apparatus Used in Exposure Process for Electronic Device

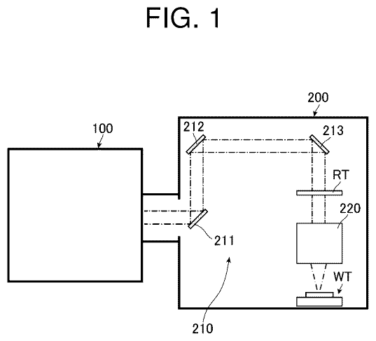

FIG. 1 is a schematic view showing a schematic configuration example of an entire electronic device manufacturing apparatus used in an exposure process for an electronic device. As shown in FIG. 1, the manufacturing apparatus used in the exposure process includes a gas laser device 100 and an exposure apparatus 200. The exposure apparatus 200 includes an illumination optical system 210 including a plurality of mirrors 211, 212, 213 and a projection optical system 220. The illumination optical system 210 illuminates a reticle pattern of a reticle stage RT with laser light incident from the gas laser device 100. The projection optical system 220 causes the laser light transmitted through the reticle to be imaged as being reduced and projected on a workpiece (not shown) arranged on a workpiece table WT. The workpiece is a photosensitive substrate such as a semiconductor wafer on which photoresist is applied. The exposure apparatus 200 synchronously translates the reticle stage RT and the workpiece table WT to expose the workpiece to the laser light reflecting the reticle pattern. Through the exposure process as described above, a device pattern is transferred onto the semiconductor wafer, thereby a semiconductor device, which is the electronic device, can be manufactured.

### 2. Description of Gas Laser Device of Comparative Example

### 2.1 Configuration

The gas laser device 100 of a comparative example will be described. The comparative example of the present disclosure is an example recognized by the applicant as known only by the applicant, and is not a publicly known example admitted by the applicant.

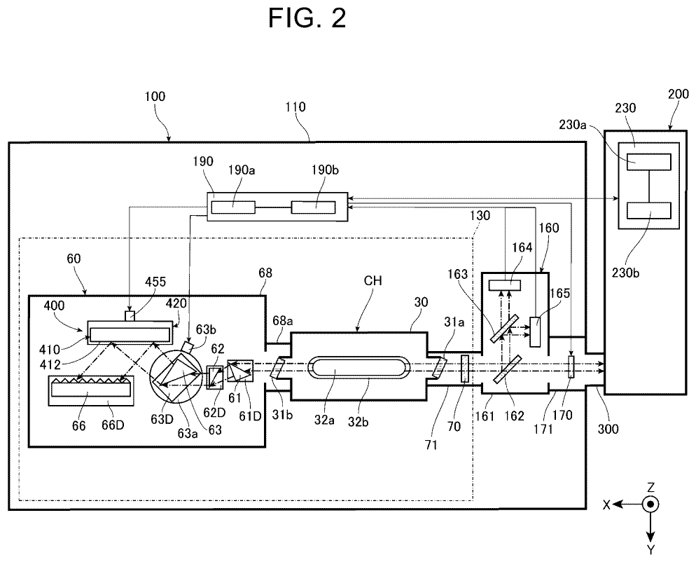

FIG. 2 is a schematic view showing a schematic configuration example of the entire gas laser device 100 of the comparative example. The gas laser device 100 is, for example, an ArF excimer laser device using a mixed gas including argon (Ar), fluorine (F₂), and neon (Ne). The gas laser device 100 outputs laser light having a center wavelength of about 193 nm. Here, the gas laser device 100 may be a gas laser device other than the ArF excimer laser device, and may be, for example, a KrF excimer laser device using a mixed gas including krypton (Kr), F₂, and Ne. In this case, the gas laser device 100 outputs laser light having a center wavelength of about 248 nm. The mixed gas containing Ar, F₂, and Ne which is a laser medium and the mixed gas containing Kr, F₂, and Ne which is a laser medium may be each referred to as a laser gas.

The gas laser device 100 includes a housing 110, and a laser oscillator 130, a detection unit 160, a shutter 170, and a laser processor 190 arranged at the internal space of the housing 110 as a main configuration.

The laser oscillator 130 includes a chamber device CH, a charger (not shown), a pulse power module (not shown), a line narrowing module 60, and an output coupling mirror 70 as a main configuration.

In FIG. 2, the internal configuration of the chamber device CH is shown as viewed from a direction substantially perpendicular to the travel direction of the laser light. The chamber device CH includes a housing 30, a pair of windows 31a, 31b, and a pair of electrodes 32a, 32b as a main configuration. In the following, a direction parallel to the optical axis direction of the laser light output from the chamber device CH is described as an X direction, a direction perpendicular to the X direction is described as a Y direction, and a direction perpendicular to the X direction and the Y direction is described as a Z direction.

The housing 30 includes an internal space in which light is generated by excitation of a laser medium in the laser gas. The light travels toward the windows 31a, 31b. The laser gas is supplied from a laser gas supply source (not shown) to the internal space of the housing 30 through a pipe (not shown).

The pair of windows 31a, 31b are provided on a wall surface of the housing 30. The window 31a is located at one end side in the travel direction of the laser light in the housing 30, and the window 31b is located at the other end side in the travel direction. The windows 31a, 31b are inclined at the Brewster angle with respect to the travel direction of the laser light so that P-polarized light of the laser light is suppressed from being reflected. The laser light oscillated as described later is output to the outside of the housing 30 through the windows 31a, 31b.

At the internal space of the housing 30, the electrodes 32a, 32b are spaced apart from and faced to each other, and each longitudinal direction thereof is along the X direction. The electrode 32b is located below the electrode 32a in the Z direction, and is shown larger than the electrode 32a in FIG. 2 for easy viewing, but is generally the same size as the electrode 32a. The space between the electrode 32a and the electrode 32b is sandwiched by the window 31a and the window 31b. The electrodes 32a, 32b are discharge electrodes for exciting the laser medium by glow discharge. In the present example, the electrode 32a is the cathode and the electrode 32b is the anode.

The electrode 32a is supported by an electrically insulating portion (not shown) that closes an opening (not shown) of the housing 30. Examples of the material of the electrical insulating portion include alumina ceramics having low reactivity with an Fe gas. Further, a feedthrough (not shown) made of a conductive member is arranged in the electrical insulating portion. The feedthrough applies a voltage, to the electrode 32a, supplied from the pulse power module. The electrode 32b is supported by an electrode holder portion (not shown) and is electrically connected to the electrode holder portion.

The charger (not shown) is a DC power source device that charges a charging capacitor (not shown) provided in the pulse power module with a predetermined voltage. The charger is arranged outside the housing 30 and is connected to the pulse power module. The pulse power module includes a switch (not shown) controlled by the laser processor 190. When the switch is turned ON from OFF, the pulse power module generates a pulse high voltage from the electric energy charged in the charging capacitor and applies the high voltage between the electrode 32a and the electrode 32b. When the high voltage is applied between the electrode 32a and the electrode 32b, discharge occurs between the electrode 32a and the electrode 32b. The laser medium in the housing 30 is excited by the energy of the discharge, and the excited laser medium emits light when shifting to the ground state. The emitted light is transmitted through the windows 31a, 31b and is output to the outside of the housing 30.

The line narrowing module 60 includes a housing 68, and prisms 61, 62, 63, a mirror unit 400, and a grating 66 arranged at the internal space of the housing 68 as a main configuration. One end of an optical path pipe 68a is connected to the housing 68 so as to surround an opening provided in the housing 68. The other end of the optical path pipe 68a is connected to a rear side of the housing 30 so as to surround the window 31b.

The prisms 61, 62, 63 expand the beam width of the light output from the window 31b and causes the light to be incident on the grating 66. The prisms 61, 62, 63 also reduce the beam width of the light reflected from the grating 66 and returns the light to the internal space of the housing 30 through the window 31b. The prisms 61, 62, 63 wavelength-disperse the light transmitted through the respective prisms in an XY plane and output the wavelength-dispersed light.

The prisms 61, 62, 63 are fixed to mounting portions 61D, 62D, 63D that are stages, respectively. The mounting portions 61D, 62D are fixed to a bottom surface of the housing 68 at the internal space of the housing 68. On the other hand, the mounting portion 63D is fixed to a rotation stage 63a, and the rotation stage 63a is arranged on the bottom surface of the housing 68 at the internal space of the housing 68. The rotation stage 63a rotates the mounting portion 63D and the prism 63 about an imaginary rotation axis of the rotation stage 63a perpendicular to the XY plane in which the light output from the prisms 61, 62, 63 or the grating 66 is wavelength-dispersed. The rotation stage 63a is connected to a motor 63b and is rotated by the motor 63b. The motor 63b is electrically connected to the laser processor 190. The laser processor 190 adjusts the rotation angle of the rotation stage 63a by controlling the motor 63b. Here, the mounting portion 63D may be integrated with the rotation stage 63a.

The mirror unit 400 includes a mirror 410 and a holding unit 420 as a main configuration.

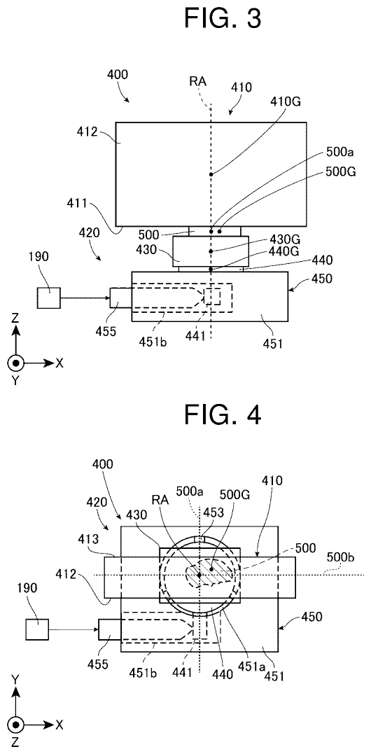

The mirror 410 is arranged between the prism 63 and the grating 66 on the optical path of the light in the line narrowing module 60. The mirror 410 reflects the light from the prism 63 toward the grating 66, and reflects the light from the grating 66 toward the prism 63. That is, the mirror 410 turns back the light traveling at the internal space of the housing 68, so that the optical path of the light is adjusted to fit a limited space at the internal space of the housing 68. The mirror 410 may be arranged between the prisms as long as the optical path of the light can be adjusted. The holding unit 420 includes a drive main body portion 455, and rotates the mirror 410 by the drive main body portion 455 about an imaginary rotation axis of the mirror 410 perpendicular to the XY plane in which the light is wavelength-dispersed. The mirror 410 and the holding unit 420 will be described later with reference to FIGS. 3, 4, 5, and 6.

When the prism 63 and the mirror 410 are slightly rotated about the respective rotation axes to change the orientation thereof, the direction of the light output from the prism 63 and the mirror 410 is changed, and the incident angle of the light incident on the grating 66 is adjusted. By adjusting the incident angle of the light on the grating 66, the wavelength of the light reflected by the grating 66 and entering the chamber device CH is adjusted. Accordingly, the light output from the window 31b of the housing 30 is reflected by the grating 66 via the prisms 61, 62, 63 and the mirror 410, so that the wavelength of the light incident on the housing 30 is adjusted to a desired wavelength. Here, the number of prisms is three in the present example, but may be two or less or four or more as long as at least one prism to be rotated as the prism 63 is included.

The surface of the grating 66 is configured of a material having a high reflectance, and a large number of grooves are formed on the surface at predetermined intervals. The cross sectional shape of each groove is, for example, a right-angled triangle. The grating 66 reflects the light incident on the grating 66 from the mirror 410 by these grooves, wavelength-disperses the light in the XY plane, and diffracts the light in a direction corresponding to the wavelength of the light. The grating 66 is arranged in the Littrow arrangement, which causes the incident angle of the light incident on the grating 66 from the mirror 410 to coincide with the diffraction angle of the diffracted light having the desired wavelength. Thus, light having a wavelength close to the desired wavelength returns to the housing 30 via the prisms 61, 62, 63 and the mirror 410. The grating 66 is fixed to the mounting portion 66D, which is a stage, and the mounting portion 66D is fixed to the housing 68 at the internal space of the housing 68.

The output coupling mirror 70 is arranged at the internal space of an optical path pipe 71 connected to a front side of the housing 30, and faces the window 31a. The output coupling mirror 70 transmits a part of the laser light from the window 31a, and reflects another part of the laser light to return to the internal space of the housing 30 through the window 31a. Thus, the grating 66 and the output coupling mirror 70 configure a Fabry-Perot laser resonator, and the housing 30 is arranged on the optical path of the laser resonator.

The detection unit 160 includes a housing 161, and beam splitters 162, 163, an optical sensor 164, and a wavelength monitor 165 arranged at the internal space of the housing 161 as a main configuration. An opening is formed in the housing 161, and the optical path pipe 71 is connected to surround the opening.

The beam splitter 162 is arranged on the optical path of the laser light. Further, the beam splitter 162 transmits a part of the laser light traveling from the output coupling mirror 70 side to the shutter 170 at a high transmittance, and reflects another part of the laser light toward the beam splitter 163. The beam splitter 163 transmits a part of the laser light from the beam splitter 162 to the optical sensor 164, and reflects another part of the laser light toward the wavelength monitor 165.

The optical sensor 164 measures a pulse energy E of the laser light incident on a light receiving surface of the optical sensor 164. The optical sensor 164 is electrically connected to the laser processor 190, and outputs a signal related to the measured pulse energy E to the laser processor 190. The wavelength monitor 165 includes a spectrometer and an image sensor. The spectrometer forms interference fringes of the laser light from the beam splitter 163 on the light receiving surface of the image sensor. The image sensor generates image data of the interference fringes. The image sensor is electrically connected to the laser processor 190, and outputs a signal related to the generated image data to the laser processor 190.

An opening is provided in the housing 161 on a side opposite to the side to which the optical path pipe 71 is connected, and an optical path pipe 171 is connected so as to surround the opening. Further, the optical path pipe 171 is connected to the housing 110, and the shutter 170 is arranged in the optical path pipe 171.

The internal spaces of the optical path pipes 68a, 71, 171 and the housings 68, 161 are supplied and filled with a purge gas. The purge gas includes an inert gas such as nitrogen (Ne). The purge gas is supplied from a purge gas supply source (not shown) through a pipe (not shown). The optical path pipe 171 is in communication with the exposure apparatus 200 through the opening of the housing 110 and the optical path pipe 300 connecting the housing 110 and the exposure apparatus 200. As will be described later, the laser light having passed through the shutter 170 enters the exposure apparatus 200.

The laser processor 190 of the present disclosure is a processing device including a storage device 190a in which a control program is stored and a central processing unit (CPU) 190b that executes the control program. The laser processor 190 is specifically configured or programmed to perform various processes included in the present disclosure and controls the entire gas laser device 100.

The laser processor 190 transmits and receives various signals to and from an exposure processor 230 of the exposure apparatus 200. For example, the laser processor 190 receives a signal indicating a later-described light emission trigger Tr and a later-described target energy Et from the exposure processor 230. The target energy Et is a target value of the energy of the laser light to be used in the exposure process. The laser processor 190 controls the charge voltage of the charger based on the pulse energy E and the target energy Et received from the optical sensor 164 and the exposure processor 230, respectively. By controlling the charge voltage, the pulse energy of the laser light is controlled. Further, the laser processor 190 transmits a command signal of ON or OFF of the switch to the pulse power module.

The laser processor 190 is electrically connected to the shutter 170 and controls opening and closing of the shutter 170. Specifically, the laser processor 190 closes the shutter 170 until a difference ΔE between the pulse energy E received from the detection unit 160 and the target energy Et received from the exposure processor 230 falls within an allowable range. When the difference ΔE falls within the allowable range, the laser processor 190 transmits, to the exposure processor 230, a reception preparation completion signal indicating that reception preparation of the light emission trigger Tr is completed. The exposure processor 230 transmits a signal indicating the light emission trigger Tr to the laser processor 190 when receiving the reception preparation completion signal, and the laser processor 190 opens the shutter 170 when receiving the signal indicating the light emission trigger Tr. The light emission trigger Tr is defined by a predetermined repetition frequency f and a predetermined number of pulses P of the laser light, is a timing signal for the exposure processor 230 to cause the laser oscillator 130 to perform laser oscillation, and is an external trigger. The repetition frequency f of the laser light is, for example, equal to or more than 100 Hz and equal to or less than 10 kHz.

Further, the laser processor 190 receives a signal related to the image data from the wavelength monitor 165, and measures the wavelength of the laser light using the image data. Further, for example, the laser processor 190 further receives, from the exposure processor 230, a signal indicating a target long wavelength λ_{L}t, a target short wavelength λ_{S}t, and the like of the laser light. In synchronization with the light emission trigger Tr, the laser processor 190 controls the motor 63b to rotate the prism 63 and controls the holding unit 420 to rotate the mirror 410 so that the measured wavelength of the laser light is periodically switched to either the target long wavelength λ_{L}t or the target short wavelength λ_{S}t. Thus, the incident angle of the laser light on the grating 66 is adjusted, and the wavelength of the laser light is periodically switched to either the target long wavelength λ_{L}t or the target short wavelength λ_{S}t. Here, the wavelength of the laser light is coarsely adjusted by rotation adjustment of the prism 63, and the wavelength of the laser light is finely adjusted by rotation adjustment of the mirror 410.

The exposure processor 230 of the present disclosure is a processing device including a storage device 230a in which a control program is stored and a CPU 230b that executes the control program. The exposure processor 230 is specifically configured or programmed to perform various processes included in the present disclosure. Further, the exposure processor 230 controls the entire exposure apparatus 200.

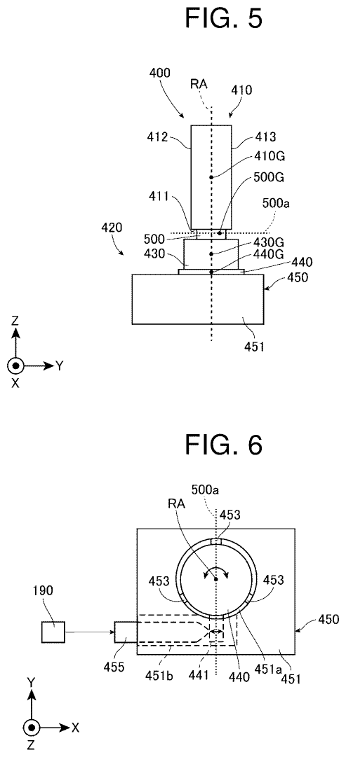

Next, the mirror unit 400 of the comparative example will be described. FIG. 3 is a front view of the mirror unit 400 of the comparative example, FIG. 4 is a top view of the mirror unit 400 of the comparative example, and FIG. 5 is a side view of the mirror unit 400 of the comparative example.

The mirror 410 of the mirror unit 400 includes a bottom surface 411, a light reflection surface 412, and a back surface 413 opposed to the reflection surface 412. The mirror 410 is held by the holding unit 420 so as to be rotatable about a rotation axis RA of the mirror 410 perpendicular to the XY plane in which the light is wavelength-dispersed by the prisms 61, 62, 63 and the grating 66. The rotation axis RA is an imaginary axis perpendicular to the bottom surface 411, parallel to an in-plane direction of the reflection surface 412, and passing through the mirror 410.

The holding unit 420 includes a base plate 430, a rotation stage 440, and a drive unit 450.

The base plate 430 has a rectangular parallelepiped shape, a main surface of the base plate 430 has a rectangular shape, and the bottom surface 411 of the mirror 410 is fixed to the base plate 430 with an adhesive 500. In FIG. 4, the adhesive 500 is hatched for easy viewing. The base plate 430 is located inward with respect to the mirror 410 in the X direction, and protrudes outward with respect to the mirror 410 in the Y direction. Therefore, the mirror 410 is fixed to the base plate 430 with the adhesive 500 on a part of the bottom surface 411.

The adhesive 500 may be, for example, an epoxy resin, and the adhesive 500 is cured and shrunk at the time of bonding. The adhesive 500 of the comparative example is provided in a part of a region at which the bottom surface 411 of the mirror 410 and the base plate 430 overlap each other, and is provided without protruding from the bottom surface 411 of the mirror 410 and the base plate 430.

The base plate 430 is arranged on the rotation stage 440 so as to be rotatable about the rotation axis RA by the rotation stage 440. When the base plate 430 is rotated by the rotation stage 440, the mirror 410 also rotates about the rotation axis RA.

In a state in which the mirror 410 is fixed to the base plate 430 with the adhesive 500 and the base plate 430 is arranged on the rotation stage 440, a centroid 410G of the mirror 410, a centroid 430G of the base plate 430, and a centroid 440G of the rotation stage 440 are located on the rotation axis RA. The centroid 410G is the centroid of the mirror 410 including a lever 441, which will be described later, attached to the rotation stage 440. The centroid 500G of the adhesive 500 deviates from the rotation axis RA. The centroid 500G is a point at which the resultant force of the centrifugal force generated in the XY plane surrounded by the adhesive 500 is balanced when the adhesive 500 rotates about the rotation axis RA. In FIGS. 3, 4, and 5, when viewed along the rotation axis RA, an imaginary axis perpendicular to the rotation axis RA and perpendicular to the reflection surface 412 of the mirror 410 is shown as a first axis 500a. Further, in FIG. 4, an imaginary axis perpendicular to the rotation axis RA and the first axis 500a is shown as a second axis 500b. The first axis 500a is along the Y-axis direction, and the second axis 500b is along the X-axis direction and parallel to the reflection surface 412.

A main surface of the rotation stage 440 has a circular shape, and the base plate 430 is fixed to one main surface of the rotation stage 440 with a fixing bolt (not shown). The rotation stage 440 is coupled to the drive unit 450 that rotates the rotation stage 440 about the rotation axis RA to rotate the base plate 430.

FIG. 6 is a top view of the drive unit 450. The drive unit 450 includes a stage block 451 and the drive main body portion 455. The stage block 451 is fixed to the housing 68 at the internal space of the housing 68. The stage block 451 is provided with a circular opening 451a and a rectangular hole 451b. The opening 451a penetrates the stage block 451 in the Z direction. The hole 451b is provided inside the stage block 451, extends in the X direction, and communicates with the opening 451a at an end portion in the X direction.

The rotation stage 440 is provided in the opening 451a. The rotation stage 440 is coupled to the stage block 451 via a plurality of spokes 453. The spokes 453 are coupled to an outer peripheral surface of the rotation stage 440 and an inner peripheral surface of the stage block 451 in the opening 451a. The rotation stage 440 protrudes from the stage block 451 toward the mirror 410 in the Z direction. The lever 441 is attached to the outer peripheral surface of the rotation stage 440 at a position different from those of the spokes 453. The lever 441 extends from the opening 451a to the hole 451b. The drive main body portion 455 is in contact with an end portion of the lever 441 opposite to the rotation stage 440.

The drive main body portion 455 is located in the hole 451b and extends along the X direction. The drive main body portion 455 is electrically connected to the laser processor 190 and can finely vibrate in the X direction by the control of the laser processor 190. When the drive main body portion 455 finely vibrates in the X direction, the lever 441 vibrates in the X direction. As a result, the rotation stage 440 finely rotates at high speed about the rotation axis RA. Here, when the rotation stage 440 is finely rotated at high speed, the spokes 453 are deformed in the rotation direction in accordance with the fine rotation at high speed without being cut. Therefore, the rotation stage 440 is coupled to the stage block 451 with the spokes 453 even during the fine rotation at high speed. The stage block 451 including the spokes 453 as described above may be made of, for example, stainless steel such as SUS304.

### 2.2 Operation

Next, operation of the gas laser device 100 of the comparative example will be described.

Before the gas laser device 100 outputs the laser light, the internal spaces of the optical path pipes 68a, 71, 171, 300 and the internal spaces of the housings 68, 161 are filled with a purge gas from the purge gas supply source (not shown). Further, the laser gas is supplied from a laser gas supply device (not shown) to the internal space of the housing 30.

Before the gas laser device 100 outputs the laser light, the laser processor 190 receives a signal indicating the target energy Et and a signal indicating the light emission trigger Tr from the exposure processor 230. Upon receiving the signal indicating the target energy Et, the laser processor 190 closes the shutter 170 and drives the charger. Further, the laser processor 190 turns ON the switch of the pulse power module. Thus, the pulse power module applies a pulse high voltage from the electric energy held in the charger between the electrode 32a and the electrode 32b. The high voltage causes discharge between the electrode 32a and the electrode 32b, the laser medium contained in the laser gas between the electrode 32a and the electrode 32b is brought into an excited state, and light is emitted when the laser medium returns to the ground state. When the light is transmitted through the window 31b and further transmitted through the prisms 61, 62, 63, the width of the light is widened in the travel direction each time being transmitted, and is wavelength-dispersed each time being transmitted. The light from the prism 63 is guided by the mirror 410 to the grating 66 at a predetermined incident angle, is reflected by the grating 66 to be wavelength-dispersed, and diffracts in a direction corresponding to the wavelength. Then, the light of a desired wavelength is reflected by the grating 66 at the same reflection angle as the incident angle. The light reflected by the grating 66 passes through the prisms 61, 62, 63 and the mirror 410, and propagates from the window 31b to the internal space of the housing 30. The light propagating to the internal space of the housing 30 is line-narrowed. The line-narrowed light causes stimulated emission of the laser medium in the excited state, and the light is amplified. The light resonates between the grating 66 and the output coupling mirror 70, and is amplified every time passing through the discharge space at the internal space of the housing 30, so that laser oscillation occurs. Then, a part of the laser light is transmitted through the output coupling mirror 70 as pulse laser light and travels to the beam splitter 162.

A part of the laser light having traveled to the beam splitter 162 is reflected by the beam splitter 162. A part of the reflected laser light is transmitted through the beam splitter 163 and is received by the optical sensor 164. The optical sensor 164 measures the pulse energy E of the received laser light. The optical sensor 164 outputs a signal indicating the pulse energy E to the laser processor 190. The laser processor 190 controls the charge voltage so that the difference ΔE between the pulse energy E and the target energy Et falls within the allowable range. The laser processor 190 closes the shutter 170 until the difference ΔE falls within the allowable range. When the difference ΔE falls within the allowable range, the laser processor 190 transmits the reception preparation completion signal to the exposure processor 230. The exposure processor 230 transmits a signal indicating the light emission trigger Tr to the laser processor 190 when receiving the reception preparation completion signal, and the laser processor 190 opens the shutter 170 when receiving the signal indicating the light emission trigger Tr. Thus, the laser light travels to the exposure apparatus 200.

Further, another part of the laser light reflected by the beam splitter 162 is reflected by the beam splitter 163 and received by the wavelength monitor 165. The wavelength monitor 165 outputs a signal related to the image data of the laser light to the laser processor 190. The laser processor 190 measures the wavelength of the laser light using the received image data. In synchronization with the light emission trigger Tr, the laser processor 190 controls the motor 63b to rotate the prism 63 and controls the drive main body portion 455 to rotate the mirror 410 so that the measured wavelength of the laser light is periodically switched to either the target long wavelength λ_{L}t or the target short wavelength λ_{S}t. Thus, the incident angle of the laser light on the grating 66 is adjusted, and the wavelength of the laser light is periodically switched to either the target long wavelength λ_{L}t or the target short wavelength λ_{S}t. Then, the gas laser device 100 performs two-wavelength oscillation in which the oscillation wavelength of the pulse laser light output from the gas laser device 100 toward the exposure apparatus 200 is periodically switched to two wavelengths every one to several pulses.

### 2.3 Problem

In the line narrowing module 60 of the comparative example, the adhesive 500 is asymmetrically arranged with respect to the first axis 500a and the second axis 500b when viewed along the rotation axis RA direction, and the thickness of the adhesive 500 is uneven in the rotation axis RA direction. Therefore, as described above, the centroid 500G of the adhesive 500 deviates from the rotation axis RA. When the mirror 410 is finely rotated at high speed in such a state, unnecessary vibration may occur on the mirror 410. As a result, the incident angle of the light incident from the mirror 410 on the grating 66 may change from a presumed incident angle, and the wavelength of the light reflected by the grating 66 may change from a presumed wavelength. Therefore, it may not be possible to accurately adjust the wavelength of the light.

Therefore, in the following embodiments, the line narrowing module 60 capable of accuracy adjusting the wavelength of the light is exemplified.

### 3. Description of Line Narrowing Module of First Embodiment

Next, the line narrowing module 60 of a first embodiment will be described. Any component same as that described above is denoted by an identical reference sign, and duplicate description thereof is omitted unless specific description is needed.

### 3.1 Configuration

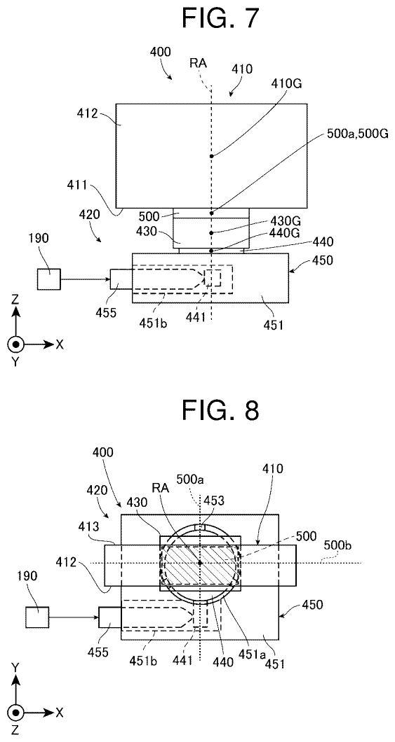

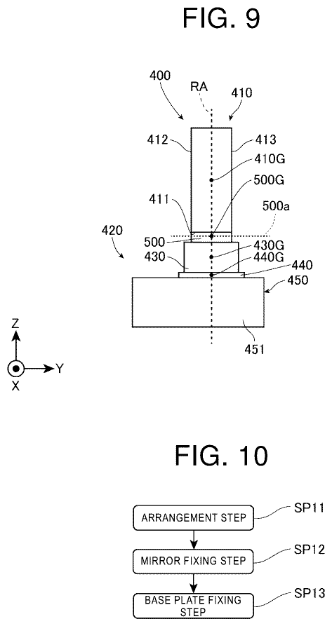

FIG. 7 is a front view of the mirror unit 400 of the present embodiment, FIG. 8 is a top view of the mirror unit 400 of the present embodiment, and FIG. 9 is a side view of the mirror unit 400 of the present embodiment. The mirror 410 of the mirror unit 400 of the present embodiment has a rectangular parallelepiped shape. The bottom surface 411 is along the XY plane and has a rectangular shape elongated in the X direction. The reflection surface 412 and the back surface 413 are along an XZ plane and perpendicular to the bottom surface 411, and have a rectangular shape elongated in the X direction.

The centroid 500G of the adhesive 500 of the present embodiment is located on the rotation axis RA together with the centroid 410G of the mirror 410, the centroid 430G of the base plate 430, and the centroid 440G of the rotation stage 440. In the present embodiment, the centroid being located on the rotation axis RA indicates that the centroid is located at a position within 0.5 mm from the rotation axis RA in the XY plane. That is, an allowable range of the deviation of the centroid with respect to the rotation axis RA is equal to or less than 0.5 mm. The adhesive 500 of the present embodiment is provided in the entire region where the bottom surface 411 of the mirror 410 and the base plate 430 overlap each other. In FIG. 8, the adhesive 500 is hatched and the adhesive 500 is shown to be smaller than the overlapping region for easy viewing. The adhesive 500 of the present embodiment is provided line-symmetrically with respect to the first axis 500a when viewed along the rotation axis RA direction. Further, the adhesive 500 is provided line-symmetrically with respect to the second axis 500b when viewed along the rotation axis RA direction.

In the rotation axis RA direction, the adhesive 500 is provided between the bottom surface 411 of the mirror 410 and the base plate 430 with a uniform thickness. For example, the thickness of the adhesive 500 in the rotation axis RA direction is equal to or more than 0.05 mm and equal to or less than 0.15 mm. For example, the bonding area of the adhesive 500 to each of the bottom surface 411 of the mirror 410 and the base plate 430 is equal to or larger than 184 mm² and equal to or smaller than 196 mm². For example, the bonding force of the adhesive 500 with respect to each of the bottom surface 411 of the mirror 410 and the base plate 430 is equal to or greater than 27 Mpa and equal to or less than 31 Mpa. Here, the thickness, the bonding area, and the boding force may be out of the respective ranges described above.

The main surface of the base plate 430 has a rectangular shape as in the comparative example, but may have, for example, a polygonal shape having an even number of vertices, an elliptical shape, or a circular shape. Examples of the polygon include a quadrangle, a hexagon, and an octagon.

The drive unit 450 of the present embodiment causes the mirror 410 to finely rotate at high speed about the rotation axis RA via the rotation stage 440 and the base plate 430. In the fine rotation at high speed, for example, the mirror 410 rotates in an angular range of equal to or more than 0.3 mrad and equal to or less than 0.9 mrad in the XY plane. Preferably, the mirror 410 rotates at an angle of 0.6 mrad. Further, the drive unit 450 rotates the rotation stage 440 about the rotation axis RA so that the incident angle of the light on the grating 66 is periodically switched to either a first incident angle or a second incident angle different from the first incident angle. The first incident angle is an angle at which the wavelength of the laser light becomes the target long wavelength Alt, and the second incident angle is an angle at which the wavelength of the laser light becomes the target short wavelength λ_{S}t.

### 3.2 Manufacturing Method of Line Narrowing Module

Next, a manufacturing method of the line narrowing module 60 of the present embodiment will be described. Hereinafter, the manufacturing method of the line narrowing module 60 may be simply referred to as a manufacturing method. FIG. 10 is a flowchart showing an assembly process in the manufacturing method of the present embodiment. In the assembly process of the present embodiment, the mirror 410, the adhesive 500, the base plate 430, and the rotation stage 440 are assembled such that the centroid 410G of the mirror 410, the centroid 500G of the adhesive 500, the centroid 430G of the base plate 430, and the centroid 440G of the rotation stage 440 are located on the rotation axis RA. The assembly process includes an arrangement step SP11, a mirror fixing step SP12, and a base plate fixing step SP13.

### (Arrangement Step SP11)

The present step is a step of arranging the mirror 410 and the base plate 430 such that the bottom surface 411 of the mirror 410 and the base plate 430 are separated from each other.

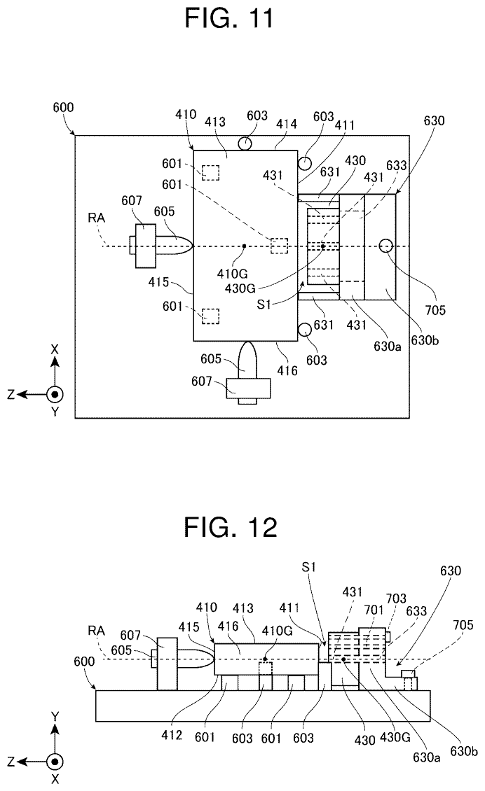

FIG. 11 is a front view of the mirror 410 in the present step, and FIG. 12 is a side view of the mirror 410 in the present step. In FIGS. 11 and 12, before the adhesive 500 is applied to the mirror 410 and the base plate 430, the mirror 410 and the base plate 430 are positioned by jigs 600, 630, respectively. The jig 600 is a jig different from the jig 630.

The jig 600 has a flat plate shape, a main surface of the jig 600 is located in the XZ plane, and three support tables 601 are provided on the main surface as being separated from each other. The support tables 601 are integrally formed with the jig 600, the reflection surface 412 of the mirror 410 is in contact with each of the support tables 601, and each of the support tables 601 supports the mirror 410. At this time, the reflection surface 412 and the back surface 413 are located in the XZ plane, and the bottom surface 411 is located in the XY plane. One of the three support tables 601 is provided at a position overlapping the rotation axis RA, and is provided closer to the bottom surface 411 than the remaining two support tables 601. The remaining two support tables 601 are provided at positions that are line-symmetrical with respect to the rotation axis RA.

On the main surface of the jig 600, three positioning pins 603 and two support tables 607 for individually supporting two plungers 605 are provided. The positioning pins 603 are integrally formed with the jig 600, and the support table 607 is fixed to the jig 600 with a fixing bolt (not shown).

Two positioning pins 603 are aligned with each other in the X direction, are provided at positions that are line-symmetrical with respect to the rotation axis RA, and face the bottom surface 411. The remaining one positioning pin 603 faces a side surface 414 that is in contact with the bottom surface 411, the reflection surface 412, and the back surface 413.

One of the plungers 605 is arranged on the rotation axis RA and abuts against the side surface 415 opposed to the bottom surface 411 to urge the mirror 410 toward the two positioning pins 603 aligned with each other in the X direction. Thus, the bottom surface 411 of the mirror 410 is pressed by the two positioning pins 603. The other of the plungers 605 is provided on the side opposite to the remaining one positioning pin 603 with the mirror 410 therebetween, abuts against a side surface 416 opposed to the side surface 414, and urges the mirror 410 toward the remaining one positioning pin 603. Thus, the side surface 414 is pressed against the remaining one positioning pin 603. Thus, the mirror 410 is positioned by the positioning pins 603 and the plungers 605.

The base plate 430 includes three injection ports 431 having a same inner diameter for injecting the adhesive 500 into a later-described gap S1. The injection ports 431 are arranged along the Z direction and are arranged at equal intervals in the X direction perpendicular to the rotation axis RA. One of the injection ports 431 is located on the rotation axis RA as described later. The remaining two injection ports 431 are provided at positions that are line-symmetrical with respect to the one injection port 431 when viewed along a direction perpendicular to the reflection surface 412, that is, with respect to the rotation axis RA.

A sectional shape of the jig 630 in a YZ plane is L-shaped, and the jig 630 includes a flat plate portion 630a that erects in the Y direction with respect to the jig 600, and a flat plate portion 630b that is connected to the flat plate portion 630a on a side opposite to the mirror 410 with respect to the flat plate portion 630a and is arranged on the main surface of the jig 600. In the flat plate portion 630a of the jig 630, the base plate 430 is positioned on the jig 630 by the positioning pin 701 being inserted into the base plate 430 and the jig 630, and the jig 630 supports the base plate 430 by the fixing bolt 703 fixing the base plate 430 to the jig 630. The jig 630 supporting the base plate 430 is fixed to the jig 600 by the fixing bolt 705 at the flat plate portion 630b such that the base plate 430 faces the bottom surface 411 and the middle injection port 431 among the three is located on the rotation axis RA. Due to the fixing, the centroid 430G of the base plate 430 is located on the rotation axis RA.

A pair of protrusions 631 are provided on the flat plate portion 630a of the jig 630, and the protrusions 631 are located on the outer side of the base plate 430 supported by the jig 630. When the jig 630 supporting the base plate 430 is fixed to the jig 600 as described above, the protrusions 631 abut to regions of the bottom surface 411 not overlapping the base plate 430. When the protrusions 631 abut to the bottom surface 411, the protrusions 631 protrude from the jig 630 so that a gap S1 is provided between the bottom surface 411 and the base plate 430 in the Z direction. That is, the mirror 410 and the base plate 430 are not in contact with each other. The adhesive 500 is injected into the gap S1 through the injection ports 431 as described later. Thus, the present step is a step of arranging the mirror 410 and the base plate 430 in which the bottom surface 411 of the mirror 410 and the base plate 430 are separated from each other by the protrusions 631 to provide the gap S1 in a state in which the mirror 410 is positioned by the jig 600 and the base plate 430 is supported by the jig 630. When the mirror 410 and the base plate 430 are arranged, the present step ends and the manufacturing method proceeds to the mirror fixing step SP12.

### (Mirror Fixing Step SP12)

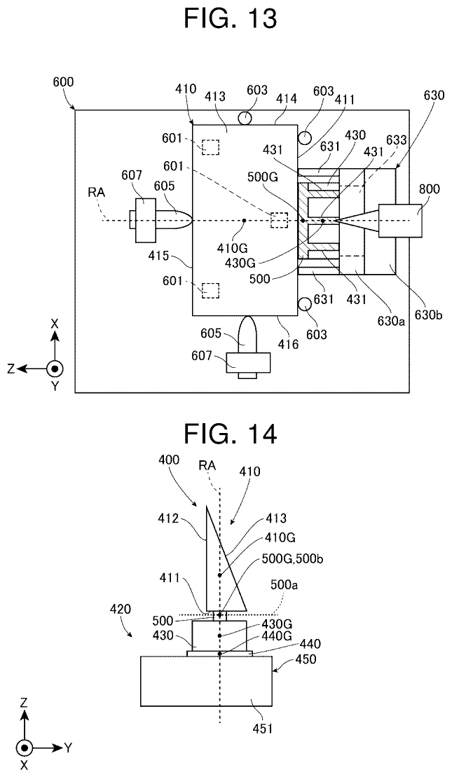

The present step is a step of fixing the mirror 410 to the base plate 430 with the adhesive 500 such that the centroid 410G of the mirror 410, the centroid 500G of the adhesive 500, and the centroid 430G of the base plate 430 are located on the rotation axis RA. FIG. 13 is a view showing a state in which an injector 800 of the adhesive 500 is inserted into the injection ports 431 and the adhesive 500 is applied to the bottom surface 411 of the mirror 410 and the base plate 430. A notch 633 is provided in a region of the jig 630 that overlaps the injection ports 431, and the injector 800 is directly inserted into the injection ports 431 through the notch 633. The adhesive 500 is injected from the injector 800 into the gap S1 through the injection ports 431. Thus, the adhesive 500 is injected from the back surface side of the base plate 430 opposite to the mirror 410. In the present embodiment, one injector 800 is sequentially inserted into the three injection ports 431, and the adhesive 500 is sequentially injected through the respective injection ports 431. An injection amount of the adhesive 500 may be adjusted while an operator visually checks the application range of the adhesive 500 so that the centroid 500G of the adhesive 500 after curing is located on the rotation axis RA. According to this method, the adhesive 500 can be arranged in the gap S1 with the centroid 500G located on the rotation axis RA. The adhesive 500 bonds to the bottom surface 411 and the base plate 430 and is cured, whereby the mirror 410 is fixed to the base plate 430. Here, three injectors 800 may be individually inserted into the three injection ports 431, and the same amount of the adhesive 500 may be simultaneously injected through the respective injection ports 431. Here, the adhesive 500 may remain in the injection ports 431. Here, the amount of the adhesive 500 remaining in each injection port 431 may be adjusted so that the centroid 430G of the base plate 430 does not deviate from the rotation axis RA. For example, the amounts of the adhesive 500 remaining in the injection ports 431 may be equal to each other.

As described above, in the present step, the mirror 410 is fixed to the base plate 430 with the adhesive 500 in a state in which the mirror 410 is positioned on the jig 600 and the base plate 430 is supported by the jig 630. Specifically, the present step is a step of injecting the adhesive 500 into the gap S1 through the injection ports 431 and fixing the mirror 410 to the base plate 430 with the injected adhesive 500. As a result, the centroid 410G of the mirror 410, the centroid 500G of the adhesive 500, and the centroid 430G of the base plate 430 are located on the rotation axis RA.

After the mirror 410 is fixed to the base plate 430, urging to the mirror 410 by the plunger 605 is released, and the fixing bolt 705 for fixing the jig 630 to the jig 600 is removed. Further, the positioning pin 701 for positioning the base plate 430 to the jig 630 and the fixing bolt 703 for fixing the base plate 430 to the jig 630 are removed. Then, the base plate 430 to which the mirror 410 is fixed is removed from the jig 600 and the jig 630. Then, the present step ends, and the manufacturing process proceeds to the base plate fixing step SP13.

### (Base Plate Fixing Step SP13)

The present step is a step of fixing the base plate 430, to which the mirror 410 is fixed with the adhesive 500 in the mirror fixing step SP12, to the rotation stage 440 with the fixing bolt so that the centroid 440G of the rotation stage 440 is located on the rotation axis RA. The fixing bolt engages with a hole of the base plate 430 from which the fixing bolt 703 is removed. Thus, the centroid 410G of the mirror 410, the centroid 500G of the adhesive 500, the centroid 430G of the base plate 430, and the centroid 440G of the rotation stage 440 are located on the rotation axis RA. Then, the present step ends and the manufacturing method ends.

### 3.3 Effect

In the line narrowing module 60 of the present embodiment, when the drive unit 450 rotates the rotation stage 440 about the rotation axis RA, the rotation stage 440 rotates the base plate 430 about the rotation axis RA. Accordingly, the mirror 410 fixed to the base plate 430 with the adhesive 500 also rotates about the rotation axis RA. By the rotation of the mirror 410, the direction of the light from the reflection surface 412 of the mirror 410 is changed, and the incident angle of the light incident on the grating 66 is adjusted. By adjusting the incident angle, the wavelength of the light reflected by the grating 66 is adjusted. Incidentally, in the line narrowing module 60 of the present embodiment, the centroid 410G of the mirror 410, the centroid 500G of the adhesive 500, the centroid 430G of the base plate 430, and the centroid 440G of the rotation stage 440 are located on the rotation axis RA. According to this configuration, compared with a case in which any of the centroids 410G, 500G, 430G, 440G is not located on the rotation axis RA, it is possible to suppress occurrence of unnecessary vibration of the mirror 410 even when the mirror 410 is finely rotated at high speed. As a result, the incident angle of the light incident on the grating 66 can be suppressed from changing from a presumed incident angle, and the wavelength of the light reflected by the grating 66 can be suppressed from changing from a presumed wavelength. Therefore, in the line narrowing module 60 of the present embodiment, the wavelength of the light can be accurately adjusted.

Further, when the centroids 410G, 500G, 430G, 440G are located on the rotation axis RA, peeling of the mirror 410 from the base plate 430 and unexpected tilting of the mirror 410 with respect to the base plate 430 can be suppressed at the time of fine rotation of the mirror 410 at high speed. As a result, the incident angle of the light incident on the grating 66 can be suppressed from changing from a presumed incident angle, and the wavelength of the light reflected by the grating 66 can be suppressed from changing from a presumed wavelength.

Further, when unnecessary vibration of the mirror 410 is suppressed from occurring as described above, the propagation of the vibration to the prisms 61, 62, 63 and the grating 66 via the housing 68 can be suppressed, and unstableness of the prisms 61, 62, 63 and the grating 66 can be suppressed. As a result, the incident angle of the light incident on the grating 66 can be further suppressed from changing from a presumed incident angle, and the wavelength of the light reflected by the grating 66 can be suppressed from changing from a presumed wavelength.

Further, in the line narrowing module 60 of the present embodiment, in the rotation axis RA direction, the adhesive 500 is provided between the bottom surface 411 of the mirror 410 and the base plate 430 with a uniform thickness. According to this configuration, it is possible to suppress the centroid 500G of the adhesive 500 from deviating from the rotation axis RA as compared with a case in which the adhesive 500 is provided between the bottom surface 411 and the base plate 430 with thickness. Here, provided that the centroid 500G of the adhesive 500 is located on the rotation axis RA, the adhesive 500 may not be provided, with a uniform thickness, between the bottom surface 411 of the mirror 410 and the base plate 430 in the rotation axis RA direction.

Further, in the line narrowing module 60 of the present embodiment, the drive unit 450 rotates the rotation stage 440 about the rotation axis RA so that the incident angle of the light on the grating 66 is periodically switched to either the first incident angle or the second incident angle different from the first incident angle.

In this configuration, the wavelength of the light reflected by the grating 66 is periodically switched to two wavelengths, and two-wavelength oscillation is performed. A workpiece irradiated with the laser light by the two-wavelength oscillation may be irradiated with two beams of the laser light each having a different focal depth. The focal depth of the two beams of the laser light is shifted between a shallow portion and a deep portion with respect to the workpiece as compared with a case of one-wavelength oscillation in which the focal depth is not changed. By irradiating a same position of the workpiece with these two beams of the laser light, for example, a thin and deep uniform hole can be formed in the workpiece as compared with the case of one-wavelength oscillation. Here, the drive unit 450 may not rotate the rotation stage 440 about the rotation axis RA so that the incident angle of the light is periodically switched to either the first incident angle or the second incident angle.

The adhesive 500 of the present embodiment is provided line-symmetrically with respect to each of the first axis 500a and the second axis 500b when viewed along the rotation axis RA direction. However, if the centroid 500G of the adhesive 500 is located on the rotation axis RA, the adhesive 500 may not be provided line-symmetrically with respect to each of the first axis 500a and the second axis 500b. Further, the reflection surface 412 may be inclined with respect to the bottom surface 411, or the rotation axis RA may be inclined with respect to the reflection surface 412. In the base plate 430 of the present embodiment, the injection port 431 may not be provided on the rotation axis RA. In the base plate 430 of the present embodiment, three injection ports 431 are provided, but the number of the injection ports 431 is not particularly limited. When an even number of injection ports 431 are provided, the injection ports 431 may be provided at positions line-symmetrical with respect to the rotation axis RA when viewed along a direction perpendicular to the reflection surface 412. When an odd number of injection ports 431 are provided, one injection port 431 may be provided on the rotation axis RA, and the remaining injection ports 431 may be provided at positions line-symmetrical with respect to the rotation axis RA when viewed along a direction perpendicular to the reflection surface 412.

### 4. Description of Line Narrowing Module of Second Embodiment

Next, the line narrowing module 60 of a second embodiment will be described. Any component same as that described above is denoted by an identical reference sign, and duplicate description thereof is omitted unless specific description is needed.

### 4.1 Configuration

FIG. 14 is a side view of the mirror unit 400 of the present embodiment. In the mirror unit 400 of the present embodiment, the shape of the mirror 410 is different from that of the mirror 410 of the first embodiment, and the position of the adhesive 500 is different from that of the adhesive 500 of the first embodiment. In the mirror unit 400 of the present embodiment as well, the centroid 500G of the adhesive 500 is located on the rotation axis RA together with the centroid 410G of the mirror 410, the centroid 430G of the base plate 430, and the centroid 440G of the rotation stage 440.

The mirror 410 of the present embodiment has a right-angled triangular prism shape. A sectional shape of the mirror 410 in the YZ plane is a right-angled triangle, where an angle formed by the bottom surface 411 and the reflection surface 412 is right angle, and the back surface 413 is inclined with respect to the bottom surface 411.

The adhesive 500 of the present embodiment is provided on the rotation axis RA side with respect to a pair of outer edges of the bottom surface 411 along the X direction when viewed from the X direction without protruding from the bottom surface 411 so that the centroid 500G of the adhesive 500 is located on the rotation axis RA. That is, the adhesive 500 does not overlap the pair of outer edges of the bottom surface 411 along the X direction when viewed along the rotation axis RA direction, and is provided on the second axis 500b side with respect to the outer edge. Further, when viewed from the X direction, the adhesive 500 is arranged line-symmetrically with respect to the rotation axis RA. Further, similarly to the first embodiment, the adhesive 500 of the present embodiment is provided line-symmetrically with respect to each of the first axis 500a and the second axis 500b when viewed along the rotation axis RA direction.

### 4.2 Effect

In the line narrowing module 60 of the present embodiment, the mirror 410 has a right-angled triangular prism shape. According to this configuration, the weight of the mirror 410 can be reduced as compared with the rectangular parallelepiped mirror 410 in which the shape and size of the bottom surface 411 and the reflection surface 412 are the same as those of the right-angled triangular prism shaped mirror 410. As a result, fine rotation of the mirror 410 at high speed may be facilitated.

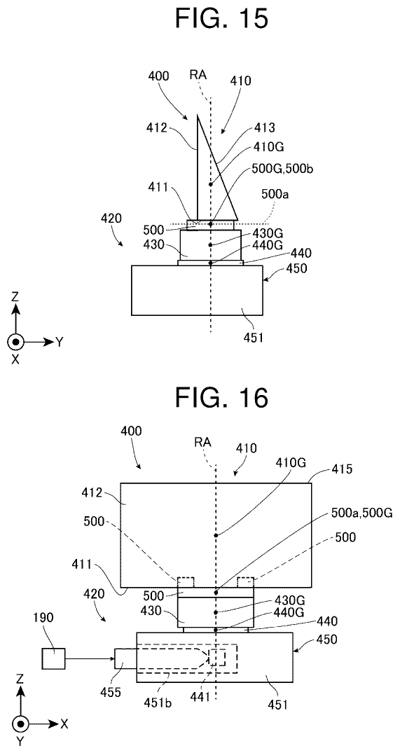

In a modification of the line narrowing module 60 of the present embodiment, as shown in FIG. 15, the adhesive 500 may be provided such that a part thereof protrudes from the bottom surface 411 without overlapping the bottom surface 411, and the remaining part does not protrude from the bottom surface 411 as overlapping the bottom surface 411 so that the centroid 500G of the adhesive 500 is located on the rotation axis RA. In this case, the part is provided on a side opposite to the rotation axis RA with respect to the outer edge on the reflection surface 412 side of the pair of outer edges of the bottom surface 411 along the X direction when viewed along the X direction. Further, the remaining part is provided on the rotation axis RA side with respect to the other outer edge on the back surface 413 side of the pair of outer edges of the bottom surface 411 along the X direction when viewed along the X direction. In the mirror fixing step SP12, the jig 630 is provided with a guide, and the part of the adhesive 500 described above is caused to flow so as to protrude from the bottom surface 411 by the guide.

In another modification of the line narrowing module 60 of the present embodiment, the mirror 410 may have a right-angled trapezoidal columnar shape. A sectional shape of the mirror 410 in the YZ plane is a right-angled trapezoidal, where an angle formed by the bottom surface 411 and the reflection surface 412 and an angle formed by the side surface 415 opposed to the bottom surface 411 and the reflection surface 412 are right angles, and the back surface 413 is inclined with respect to the bottom surface 411 and the side surface 415.

### 5. Description of Line Narrowing Module of Third Embodiment

Next, the line narrowing module 60 of a third t embodiment will be described. Any component same as that described above is denoted by an identical reference sign, and duplicate description thereof is omitted unless specific description is needed.

### 5.1 Configuration

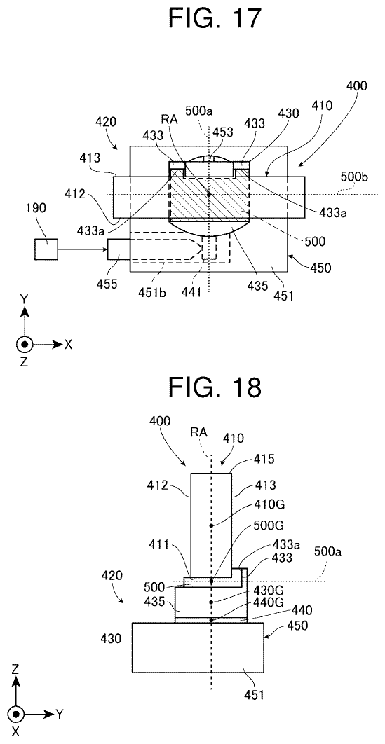

FIG. 16 is a front view of the mirror unit 400 of the present embodiment, FIG. 17 is a top view of the mirror unit 400 of the present embodiment, and FIG. 18 is a side view of the mirror unit 400 of the present embodiment. The mirror unit 400 of the present embodiment differs from that of the first embodiment in that the base plate 430 is different from the base plate 430 of the first embodiment, and the mirror 410 is further fixed to the base plate 430 with the adhesive 500. In FIG. 17, the adhesive 500 is hatched and the adhesive 500 is shown to be smaller than the region to which the adhesive 500 is applied for easy viewing. Further, the adhesive 500 of the present embodiment differs from that of the first embodiment in that it is not provided line-symmetrically with respect to the second axis 500b when viewed along the rotation axis RA direction. In the mirror unit 400 of the present embodiment as well, the centroid 500G of the adhesive 500 is located on the rotation axis RA together with the centroid 410G of the mirror 410, the centroid 430G of the base plate 430, and the centroid 440G of the rotation stage 440.

The base plate 430 of the present embodiment further includes a pair of protrusions 433 protruding in the rotation axis RA direction from a surface of the base plate 430 to which the bottom surface 411 of the mirror 410 is to be bonded. The pair of protrusions 433 are provided line-symmetrically with respect to the first axis 500a in the X direction along the reflection surface 412 and perpendicular to the rotation axis RA. The protrusions 433 are located lower than the side surface 415 of the mirror 410 opposed to the bottom surface 411 in the Z direction, and is located inward with respect to the mirror 410 in the X direction. For example, the protrusions 433 have a rectangular parallelepiped shape.

Each of the protrusions 433 is provided with an abutting surface 433a facing the back surface 413 of the mirror 410 and smaller than the back surface 413. The back surface 413 is further fixed to the respective abutting surfaces 433a with the adhesive 500. The amounts of the adhesive 500 are the same on the abutting surfaces 433a. The adhesive 500 on the back surface 413 may be the epoxy resin same as the adhesive 500 on the bottom surface 411. Further, the adhesive 500 on the back surface 413 is integrated with the adhesive 500 on the bottom surface 411.

In the base plate 430 of the present embodiment, the centroid 430G of the base plate 430 is located on the rotation axis RA even with the pair of protrusions provided. Therefore, the base plate 430 of the present embodiment includes a protrusion portion 435 protruding toward the reflection surface 412 in a direction further away from the rotation axis RA than the bottom surface 411. In the XY plane, the protruding amount of the protrusion portion 435 with respect to the bottom surface 411 increases as the distance from the first axis 500a decreases. Therefore, the point of the protrusion portion 435 farthest from the bottom surface 411 of the mirror 410 when viewed along the rotation axis RA overlaps the first axis 500a.

Further, in the adhesive 500 on the bottom surface 411 of the present embodiment, the adhesive 500 on the bottom surface 411 is located on the rotation axis RA even with the adhesive 500 on the back surface 413 provided. Therefore, the adhesive 500 on the bottom surface 411 of the present embodiment is provided on the base plate 430 from the bottom surface 411 of the mirror 410 to the protrusion portion 435 as protruding in the Y direction.

### 5.2 Manufacturing Method of Line Narrowing Module

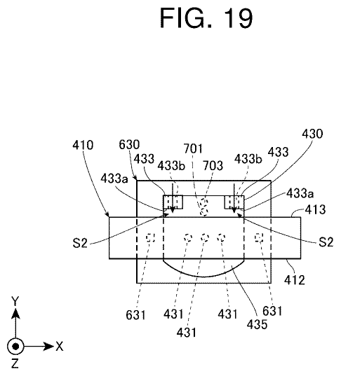

Next, a manufacturing method of the line narrowing module 60 of the present embodiment will be described. FIG. 19 is a view for explaining the arrangement step SP11 of the present embodiment. The arrangement step SP11 of the present embodiment differs from that of the first embodiment in that a gap S2 is further provided between the back surface 413 and each of the abutting surfaces 433a in the Y direction when the protrusions 631 of the jig 630 abuts to the bottom surface 411. That is, the mirror 410 and the protrusions 433 are not in contact with each other. The present step is also a step of providing the gaps S2 as separating the back surface 413 of the mirror 410 and the abutting surfaces 433a by the protrusions 631 of the jig 630 with the mirror 410 positioned by the jig 600 and the base plate 430 supported by the jig 630. The adhesive 500 is provided in the gaps S2 as described later.

Further, in the mirror fixing step SP12, the adhesive 500 is injected into the gap S1 from a back surface side of the base plate 430 being a side opposite to the mirror 410 in the first embodiment, but in the present embodiment, the adhesive 500 is further injected into the gaps S2 from a back surface side of the protrusions 433 on the side opposite to the mirror 410 as shown by arrows in FIG. 19.

Each protrusion 433 includes an injection port 433b through which the adhesive 500 is injected into the gap S2. The injection ports 433b are arranged along the Y direction. An injector (not shown in FIG. 19) is inserted into the injection ports 433b, and the adhesive 500 is injected from the injector through the injection ports 433b into the gaps S2. That is, the adhesive 500 is injected into the gaps S2 from the back surface side of the protrusions 433 on the side opposite to the mirror 410 as indicated by the arrows. An injection amount of the adhesive 500 may be adjusted while an operator visually checks the application range of the adhesive 500. The adhesive 500 bonds to the back surface 413 and the abutting surfaces 433a and is cured, whereby the mirror 410 is further fixed to the base plate 430. Thus, the present process is a step of injecting the adhesive 500 through the injection ports 431 into the gaps S2 between the back surface 413 and the abutting surfaces 433a to fix the mirror 410 further to the base plate 430 with the injected adhesive 500.

### 5.3 Effect

In the line narrowing module 60 of the present embodiment, the back surface 413 is fixed to the respective abutting surfaces 433a with the adhesive 500. According to this configuration, it is possible to suppress the mirror 410 from being unexpectedly tilted with respect to the surface of the base plate 430 to which the bottom surface 411 of the mirror 410 is bonded, and it is possible to suppress the mirror 410 from being deviated about the rotation axis RA with respect to the base plate 430. As a result, the incident angle of the light incident on the grating 66 can be suppressed from changing from a presumed incident angle, and the wavelength of the light reflected by the grating 66 can be suppressed from changing from a presumed wavelength.

In the line narrowing module 60 of the present embodiment, the shape of the protrusions 433 is not particularly limited as long as the abutting surfaces 433a are provided. The shape of the protrusion portion 435 is not particularly limited as long as the centroid 430G of the base plate 430 is located on the rotation axis RA.

The adhesive 500 on the back surface 413 may be an adhesive 500 different from the adhesive 500 on the bottom surface 411. Further, the adhesive 500 on the back surface 413 may not be integrated with the adhesive 500 on the bottom surface 411.

The description above is intended to be illustrative and the present disclosure is not limited thereto. Therefore, it would be obvious to those skilled in the art that various modifications to the embodiment of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and c.

What is claimed is:

1. A line narrowing module comprising:
a mirror including a bottom surface and a reflection surface of light;
a grating configured to wavelength-disperse the light reflected by the reflection surface;
a base plate to which the bottom surface of the mirror is fixed with an adhesive;
a rotation stage configured to rotate the base plate, arranged thereon, about a rotation axis perpendicular to a plane in which the light is wavelength-dispersed to rotate the mirror about the rotation axis; and
a drive unit configured to rotate the rotation stage about the rotation axis,
a centroid of the mirror, a centroid of the adhesive, a centroid of the base plate, and a centroid of the rotation stage being located on the rotation axis.

2. The line narrowing module according to claim 1,
wherein the rotation axis is parallel to an in-plane direction of the reflection surface, and
the adhesive is provided line-symmetrically with respect to a first axis perpendicular to the rotation axis and perpendicular to the reflection surface of the mirror when viewed along a direction of the rotation axis.

3. The line narrowing module according to claim 1,
wherein the rotation axis is parallel to an in-plane direction of the reflection surface, and
the adhesive is provided line-symmetrically with respect to a second axis perpendicular to the rotation axis and parallel to the reflection surface of the mirror when viewed along a direction of the rotation axis.

4. The line narrowing module according to claim 1,
wherein the adhesive is provided between the bottom surface of the mirror and the base plate with a uniform thickness in a direction of the rotation axis.

5. The line narrowing module according to claim 1,
wherein a thickness of the adhesive in a direction of the rotation axis is equal to or more than 0.05 mm and equal to or less than 0.15 mm,
a bonding area of the adhesive to each of the bottom surface of the mirror and the base plate is equal to or larger than 184 mm² and equal to or smaller than 196 mm², and
a bonding force of the adhesive to each of the bottom surface of the mirror and the base plate is equal to or larger than 27 Mpa and equal to or smaller than 31 Mpa.

6. The line narrowing module according to claim 1,
wherein the drive unit rotates the rotation stage about the rotation axis so that an incident angle of the light on the grating is periodically switched to either a first incident angle or a second incident angle different from the first incident angle.

7. The line narrowing module according to claim 1,
wherein the mirror has a rectangular parallelepiped shape.

8. The line narrowing module according to claim 1, wherein the mirror has a right-angled triangular prism shape.

9. The line narrowing module according to claim 1,
wherein the rotation axis is parallel to an in-plane direction of the reflection surface,
the mirror includes a back surface opposed to the reflection surface,
the base plate includes a pair of protrusions protruding in a direction of the rotation axis,
the protrusions are provided line-symmetrically with respect to a first axis perpendicular to the rotation axis and perpendicular to the reflection surface of the mirror when viewed along the direction of the rotation axis,
each of the protrusions is provided with an abutting surface facing the back surface, and
the back surface is fixed to each of the abutting surfaces with the adhesive.

10. A manufacturing method of a line narrowing module comprising:
an assembly process for assembling a mirror, an adhesive, a base plate, and a rotation stage so that a centroid of the mirror, a centroid of the adhesive, a centroid of the base plate, and a centroid of the rotation stage are located on a rotation axis perpendicular to a plane in which light is wavelength-dispersed,
the line narrowing module including:
the mirror including a bottom surface and a reflection surface of the light;
a grating configured to wavelength-disperse the light reflected by the reflection surface;
the base plate to which the bottom surface of the mirror is fixed with the adhesive;
the rotation stage configured to rotate the base plate, arranged thereon, about the rotation axis to rotate the mirror about the rotation axis; and
a drive unit configured to rotate the rotation stage about the rotation axis.

11. The manufacturing method of the line narrowing module according to claim 10,
wherein the base plate includes an injection port, and
the assembly process includes:
an arrangement step of arranging the mirror and the base plate such that the bottom surface of the mirror and the base plate are separated from each other, and
a mirror fixing step of injecting the adhesive into a gap between the bottom surface and the base plate through the injection port and fixing the mirror to the base plate with the injected adhesive.

12. The manufacturing method of the line narrowing module according to claim 11,
wherein the injection port is provided on the rotation axis.

13. The manufacturing method of the line narrowing module according to claim 12,
wherein the injection port includes injection ports provided at positions that are line-symmetrical with respect to the rotation axis when viewed along a direction perpendicular to the reflection surface.

14. The manufacturing method of the line narrowing module according to claim 11,
wherein the rotation axis is parallel to an in-plane direction of the reflection surface,
the mirror further includes a back surface opposed to the reflection surface,
the base plate includes a pair of protrusions protruding in a direction of the rotation axis,
the protrusions are provided line-symmetrically with respect to a first axis perpendicular to the rotation axis and perpendicular to the reflection surface of the mirror when viewed along the direction of the rotation axis,
each of the protrusions is provided with an abutting surface facing the back surface and an injection port communicating with the abutting surface,
in the arrangement step, the back surface of the mirror and the abutting surfaces of the protrusions are separated, and
in the mirror fixing step, the adhesive is injected into gaps between the back surface and the abutting surfaces through the injection ports of the protrusions, respectively, and the mirror is further fixed to the base plate with the injected adhesive.

15. An electronic device manufacturing method, comprising:
generating laser light using a gas laser device including a line narrowing module;
outputting the laser light to an exposure apparatus; and
exposing a photosensitive substrate to the laser light in the exposure apparatus to manufacture an electronic device,
the line narrowing module including:
a mirror including a bottom surface and a reflection surface of light;
a grating configured to wavelength-disperse the light reflected by the reflection surface;
a base plate to which the bottom surface of the mirror is fixed with an adhesive;
a rotation stage configured to rotate the base plate, arranged thereon, about a rotation axis perpendicular to a plane in which the light is wavelength-dispersed to rotate the mirror about the rotation axis; and
a drive unit configured to rotate the rotation stage about the rotation axis, and
a centroid of the mirror, a centroid of the adhesive, a centroid of the base plate, and a centroid of the rotation stage being located on the rotation axis.
